(19) United States
(12) Patent Application Publication
(10) Pub. No.: US 2016/0314115 A1
(43) Pub. Date: Oct. 27, 2016

(54) CROSS-PLATFORM MESSAGING APPLICATION

(71) Applicants: Michelle Windebank, London (GB); Mark SKeene, Croydon (GB)

(72) Inventors: Michelle Windebank, London (GB); Mark SKeene, Croydon (GB)

(21) Appl. No.: 14/695,191

(22) Filed: Apr. 24, 2015

(51) Int. Cl. G06F 17/28; H04W 4/12

(52) U.S. Cl. CPC G06F 17/289; H04W 4/12

(57) ABSTRACT

The present invention relates to generally to a cross-platform mobile messaging application. More specifically, the invention relates to a secure messaging platform that offers seamless, near real-time translation of messages that are exchanged between users that speak and read different languages.

### FIELD OF THE INVENTION

The present invention relates to generally to a cross-platform mobile messaging application. More specifically, the invention relates to a secure messaging platform that offers seamless, near real-time translation of messages that are exchanged between users that speak and read different languages.

### BACKGROUND OF THE INVENTION

As world becomes increasingly connected through the various communications platforms offered by the internet and other communication technologies, people from different cultures that speak different languages are coming into contact with each other more frequently. One of the primary barriers to efficient communication between persons that speak different languages is need to translate communications between the different languages that those persons speak. With currently available communications platforms, a recipient of a message or other communication will have to take time to translate that message if the message is not in a language the recipient is familiar with. The translation process makes communicating with someone that speaks a different language inefficient by requiring the recipient to seek alternative means to translate the message that they received.

Therefore, there is a need in the art for a cross-platform messaging application that provides translation between different languages in near real-time to increase the efficiency of communication between persons that read and speak different languages. These and other features and advantages of the present invention will be explained and will become obvious to one skilled in the art through the summary of the invention that follows.

### SUMMARY OF THE INVENTION

Accordingly, embodiments of the present invention are directed to a system and method for cross-platform mobile messaging with real-time language translation. In a preferred embodiment, a secure messaging platform is provided that offers seamless, near real-time translation of messages that are exchanged between users that speak and read different languages.

According to an embodiment of the present invention, a system for providing messaging via a computing device may include: a messaging exchange module comprising computer executable code stored in non-volatile memory; a processor; a memory; and a communications means, wherein said messaging exchange module, said processor, said memory, and said communications means are operably connected and are configured to: receive a message from a first user that is to be sent to a second user; identify a language type for said first user and said second user, wherein said first user has a first language and said second user has a second language; compare said first language to said second language; determine whether said first language is different from said second language; translate said message into a translated message via a translation process upon determining that said first language is different from said second language; and send said translated message to said second user.

According to an embodiment of the present invention, the messaging exchange module, said processor, said memory, and said communications means are operably connected and are further configured to encrypt at least one of said message and said translated message.

According to an embodiment of the present invention, the messaging exchange module, said processor, said memory, and said communications means are operably connected and are further configured to destroy at least one of said message and said translated message automatically after a designated amount of time.

According to an embodiment of the present invention, the messaging exchange module, said processor, said memory, and said communications means are operably connected and are further configured to: receive a payment request approval from said first user, wherein said first user authorizes a payment to be removed from a payment account belonging to said first user; transfer said payment from said first user to said second user, wherein said payment is deposited in a deposit account belonging to said second user.

According to an embodiment of the present invention, the messaging exchange module, said processor, said memory, and said communications means are operably connected and are further configured to send a payment request from said second user to said first user.

According to an embodiment of the present invention, the translation process is performed on a remote computing device.

According to an embodiment of the present invention, the translation process is performed a computing device of a user.

According to an embodiment of the present invention, a method for providing messaging via a computing device includes the steps of: receiving a message from a first user that is to be sent to a second user; identifying a language type for said first user and said second user, wherein said first user has a first language and said second user has a second language; comparing said first language to said second language; determining whether said first language is different from said second language; translating said message into a translated message via a translation process upon determining that said first language is different from said second language; and sending said translated message to said second user.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with embodiments of the present invention;

FIG. 2 illustrates a schematic overview of a network, in accordance with embodiments of the present invention;

FIG. 3A illustrates a schematic of a system for a cross-platform messaging application with translation capabilities, in accordance with embodiments of the present invention;

FIG. 3B illustrates a schematic of a system for a cross-platform messaging application with translation capabilities, in accordance with embodiments of the present invention;

FIG. 4 is a process flow of an exemplary method for providing a cross-platform messaging application with translation capabilities, in accordance with embodiments of the present invention; and

FIG. 5 is a process flow of an exemplary method for providing a cross-platform messaging application with translation capabilities, in accordance with embodiments of the present invention.

### DETAILED DESCRIPTION OF THE INVENTION

The present invention relates to generally to a cross-platform mobile messaging application. More specifically, the invention relates to a secure messaging platform that offers seamless, near real-time translation of messages that are exchanged between users that speak and read different languages.

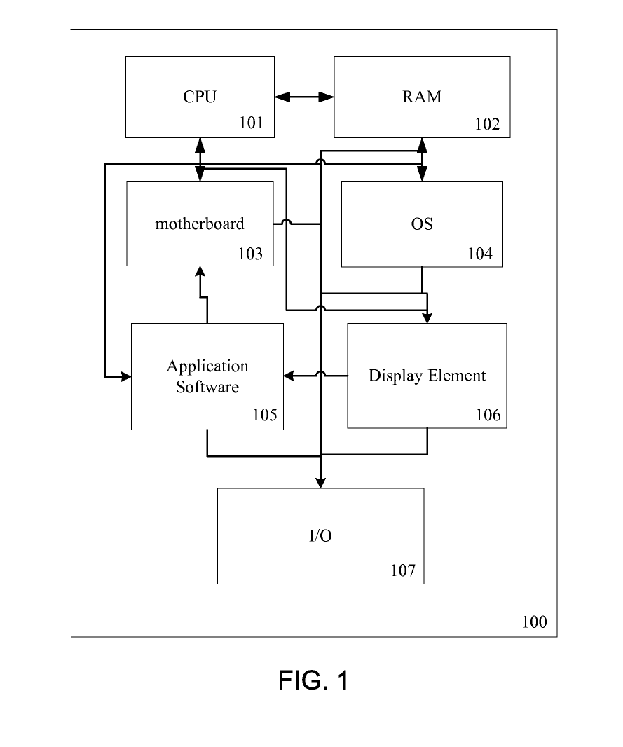

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, display element 106 and one or more input/output devices/means 107. Examples of computing devices usable with embodiments of the present invention include, but are not limited to, personal computers, smart phones, laptops, mobile computing devices and tablet PCs and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however, a user may be able to compose data offline that will be consumed by the system when the user is later connected to a network.

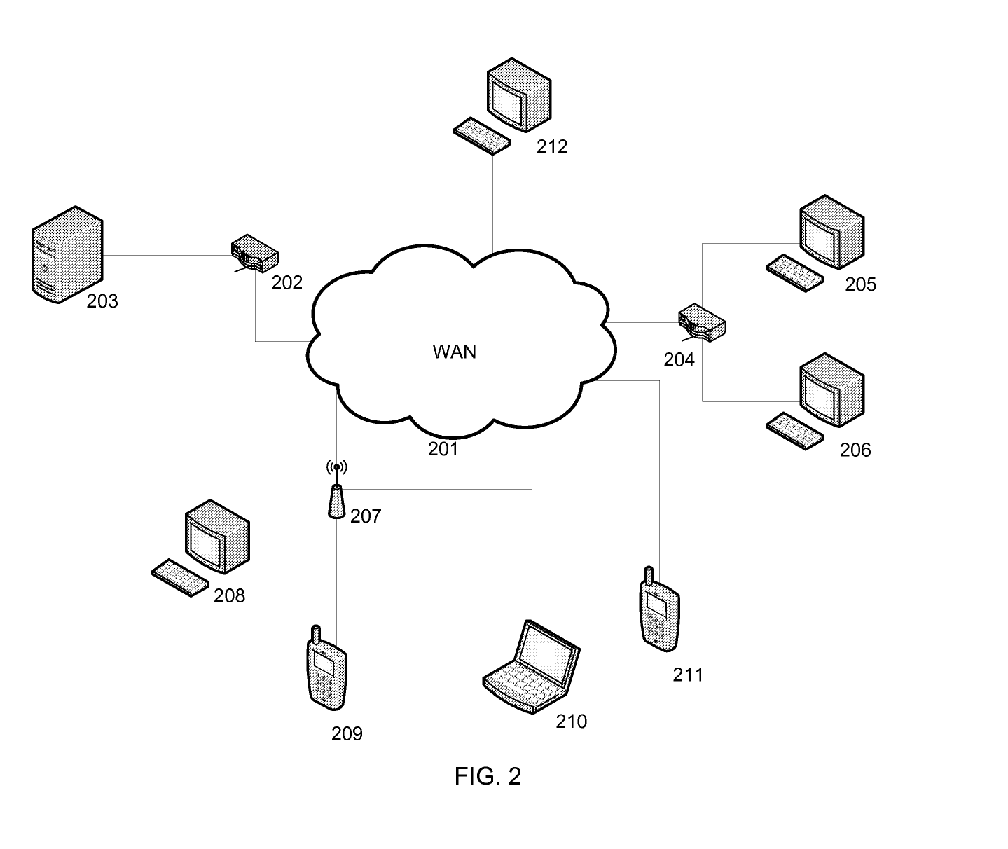

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

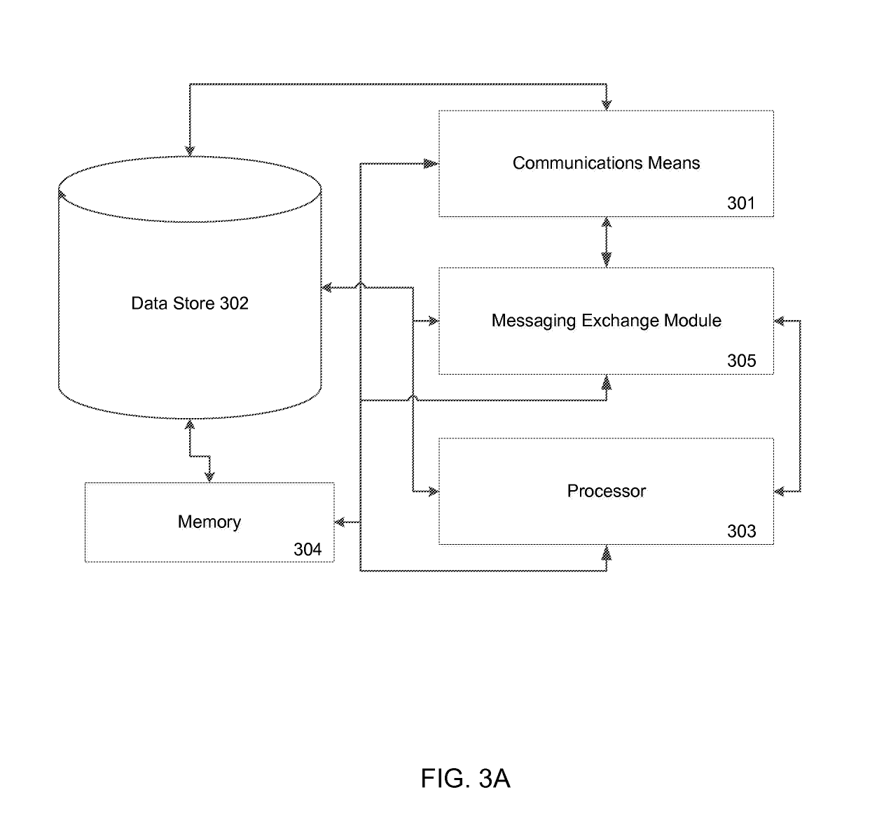

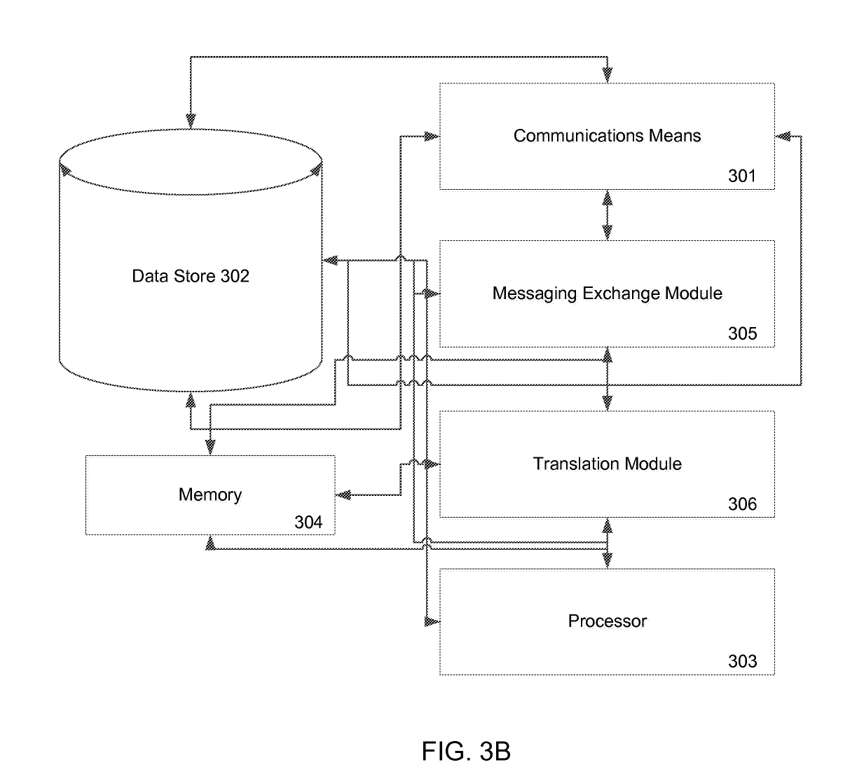

Turning to FIG. 3A, according to an embodiment of the present invention, a system for sending, receiving, and translating messages is comprised of one or more communications means 301, one or more data stores 302, a processor 303, memory 304, and a messaging exchange module 305. FIG. 3B shows an alternative embodiment of the present invention, comprised of one or more communications means 301, one or more data stores 302, a processor 303, memory 304, and a messaging exchange module 305 and a translation module 306. The various modules described herein (e.g., messaging exchange module 305 and translation module 306) provide functionality to the system, but the features described and functionality provided may be distributed in any number of modules, depending on various implementation strategies. One of ordinary skill in the art would appreciate that the system may be operable with any number of modules, depending on implementation, and embodiments of the present invention are contemplated for use with any such division or combination of modules as required by any particular implementation. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data over one or more networks or to one or more peripheral devices attached to the system. Appropriate communications means may include, but are not limited to, wireless connections, wired connections, cellular connections, data port connections, Bluetooth® connections, or any combination thereof. One of ordinary skill in the art would appreciate that there are numerous communications means that may be utilized with embodiments of the present invention, and embodiments of the present invention are contemplated for use with any communications means.

According to an embodiment of the present invention, a system and method for exchanging messages and other communications via a mobile or other computing device. In a preferred embodiment, the messaging system may be configured to perform near-real time translation of messages between users that speak and read different languages. In particular, a message sent by a first user that understands a first language will be translated, in near real-time, before being delivered to a second user that understands a second language, thereby allowing seamless and efficient communication between users that understand different languages without the need for each user to perform a translation separately. In some embodiments, the messaging system may also be configured to provide a payment system to facilitate the transfer of payments between users. In some embodiments, the messaging system may also provide a multimedia profile for each of the users to share pictures, videos, music, and other media. In some embodiments, the messaging system will incorporate security features, including but not limited to encryption and messages that self-destruct. One of ordinary skill in the art would appreciate that the messaging system of the present invention could be configured with additional or fewer features without departing from the spirit and scope of the invention and that embodiments of the present invention are contemplated for use with any such features.

According to an embodiment of the present invention, the systems and methods described herein that provide a cross-platform messaging and communications application could be implemented through a messaging exchange module. In a preferred embodiment, the messaging exchange module is configured to facilitate the sending, receiving, translation, and encryption of messages and other information exchanged via the system. In the preferred embodiment, the translation of a message may include, but is not limited to, the identification of the languages of a first and second user, a comparison of the languages of a first and second user to determine whether those languages are the same, and the translation of a message from the language of a first user to the language of the second user.

In some embodiments, the messaging exchange module may be further configured to facilitate the transfer of payments between a first and second user. In particular, the messaging exchange module may facilitate the transfer of funds from a payment account of a first user to a deposit account of a second user. The first user may be able to send a payment to a second user directly, after being requested to make a payment by the second user, or any combination thereof.

Further embodiments may utilize the payment feature to provide payment for messages requiring translation. Certain embodiments may require payment for translation of messages between one language to another. These payments, for instance, may be based on the cost to provide the translation services to the host system (e.g., cost per translated message provided by a third-party translation service). In certain embodiments, the cost to translate may be augmented with an additional price in order to create a revenue stream for the service provider. In certain embodiments, the additional price could be a flat fee, in other embodiments, the cost could be based on message length.

In some embodiments, the messaging exchange module may offer securities features that include, but are not limited to messaging and data encryption, as well as the automatic deletion and destruction of messages and other data. One of ordinary skill in the art would appreciate that a messaging exchange module could be configured to accomplish a variety of tasks, and embodiments of the present invention are contemplated for use with any such task.

According to an embodiment of the present invention the messaging exchange module will be configured to translate between different languages to facilitate seamless communication between users that that speak different languages. In the preferred embodiment, messages from a first user may be translated to the language of a second user automatically and in near real-time, thereby allowing users to communicate more efficiently as there would be no need to go through a separate or external translating process.

In a preferred embodiment, the messaging exchange module could be configured to automatically identify the different languages of the users so as to allow any exchanges to be automatically translated without any input from the user. Automatic identification of languages may be done by the messaging exchange module comparing individual words or phrases identified in a message to language databases available to the system. Upon direct or approximate match with a language, a language identifier can be assigned to the message to denote the origin language of a message.

According to an embodiment of the present invention, the language of a receiver can be determined automatically by any number of methods. A first method of identifying receiver language is via information known to the system about the user (e.g., registration information). A second method for identifying the language of a receiver is to utilize information provided to the system from the device used by the receiver to identify the user's language. In many cases, a device communicating with other devices across a network provide meta-data that allows for the identification of the language utilized by the devices. In a third method for identifying language, the system can use location information to identify the appropriate conversion language, such as identifying a recipient via an IP address or via GPS or other location based service (LBS) information provided to the system to identify a predominate language in the identified location to use as the conversion language. These are a few preferred methods for identifying the language of the receiver. However, one of ordinary skill in the art would appreciate that there are numerous methods that could be utilized for identifying the language of a receiver, and embodiments of the present invention are contemplated for use of any appropriate method of identifying the language of the receiver, whether manually provided or automatically determined.

In some embodiments, the system may give each user the option of whether to automatically translate messages. In certain embodiments, the receiver will receive a message in an untranslated state. At this point, if the system is configured to automatically translate the message, the system will automatically translate the message into the language of the receiver without first providing the untranslated message information.

In other embodiments, the system may first provide the untranslated information to the receiver before providing the translated message information. This embodiment may be useful where a receiver is learning the language of the transmitter and wishes to attempt a translation before receiving the fully translated message information.

### On-Device Processing or Remote/Distributed Processing

According to an embodiment of the present invention, the translation of message between different languages will require translation processing to occur either locally on the device of a user or remotely via one or more remote or distributed processing means. For instance, a remote processing means may include, but is not limited to, one or more translation servers or application servers utilized by the system for processing translations. A distributed processing means may include a peer-to-peer system, whereby devices in an associated group (generally connected via one or more networks) distribute the processing of data and provide the resulting processed data to an intended receiver. One of ordinary skill in the art would appreciate that there are numerous types of local, remote and distributed processing means that could be utilized with embodiments of the present invention, and embodiments of the present invention are contemplated for use with any appropriate processing means.

In a first preferred embodiment, the translation processing will occur locally on the computing device of a user. Processing the translations locally decreases demands on application servers providing the communication of message information between users, thereby reducing the remote infrastructure required to implement the system, allowing for such resources to be focused on the receipt and delivery of messages between transmitters and receivers. Further, it should be noted that translation may occur on either end of the transmission. For instance, in certain embodiments, the device of the transmitter may affect the translation of a message from a first language into a second language. In other embodiments, the computing device of a receiver will perform the translation.

In still further embodiments, information about the device of the transmitter and the device of the receiver may be used to determine which device will perform the translation. For instance, if the transmitter of a message has a device that is capable of translation (e.g., modern smartphone) and the receiver has a lower quality device (e.g., older device capable of receiving messages, but not translating), the system can determine that the translation must occur on a specific device. Conversely, if the device of the transmitter is incapable of translation, but the device of the receiver is capable of translation, the system may allow for the untranslated message to be provided from the device of the transmitter to the device of the receiver for translation. Determinations such as this may require the remote system to negotiate where the message should be translated.

Further, such determinations by the remote system may be utilized to reduce bandwidth requirements where the remote system knows the first and second languages and can determine that the second language results in larger message files (e.g., more bytes). For instance, Chinese language messages generally require less data than corresponding English messages. This may be due to several reasons, but the result is that transmitting a message in Chinese to a device that will translate the message into English is more advantageous from a transmission perspective than translating and then sending the message. While variances may be small in a single message, for a system processing large volumes of messages, the variances could be significant.

In second preferred embodiment, the translation processing occurs remotely on a server or distributed computing system that a user can connect to. By performing the translation processing remotely, users with lower power computing devices will be able to use the system more efficiently as such lower power computing devices could otherwise be overburdened by the processing demands required to constantly translate messages. One of ordinary skill in the art would appreciate that translation processing could be accomplished by of combination of both local processing on the computing device of a user and remotely on a server.

### Encryption

In certain embodiments of the present invention, the system may be configured to encrypt messages prior to transmission. In preferred embodiments, the messages are encrypted on the device of the transmitter before transmission. Further, encryption may utilize multiple connections to improve security, such as encryption of the message on the device of the transmitter which will be sent to a remote system prior to receipt by the device of the receiver, while decryption information is provided via a direct connection between the device of the transmitter and the device of the receiver. In other embodiments, the system may be configured to encrypt messages it receives from the transmitter prior to transmission to the receiver. One of ordinary skill in the art would appreciate that there are numerous types of encryption that could be utilized with embodiments of the present invention, and embodiments of the present invention are contemplated for use with any appropriate encryption type and means.

### Message Destruction

In conjunction with or in lieu of encryption, exemplary embodiments of the present invention may also use message destructibility to further enhance security and usefulness of the messaging system described herein. In preferred embodiment, availability of a message to the receiver is of a finite time period. As opposed to emails, SMS or other electronic forms of communication, destructible messages are only available for a brief period of time (e.g., 5 seconds, 10 seconds, 20 seconds, 1 minute, 1 hour, 24 hours) before no longer being available. One of ordinary skill in the art would appreciate that there are numerous methods for providing message destructibility, and embodiments of the present invention are contemplated for use with any appropriate method for providing message destructibility.

### Payment System

According to an embodiment of the present invention, the system may be configured to provide a payment system for use between transmitters and receivers and/or payment by users of the system for costs associated with translation services. In preferred embodiments, the system may be configured to link financial accounts (e.g., bank accounts) or third party payment providers (e.g., PAYPAL) or other payment means (e.g., Bitcoin wallets) of transmitters and receivers for affecting payment between parties. Advantageously, requests for payments and even currencies can be translated between a first language/currency and a second language/currency. Similar to languages, the system may identify currencies used by the transmitter and receiver by identifying the source currency through similar means as identifying languages above. One of ordinary skill in the art would appreciate that there are numerous methods for identifying currency types and providing payment between transmitters and receivers, and embodiments of the present invention are contemplated for use with any appropriate means and methods for identifying currencies and providing currency conversion and payment between parties.

Further embodiments may utilize the payment feature to provide payment for messages requiring translation. Certain embodiments may require payment for translation of messages between one language to another. These payments, for instance, may be based on the cost to provide the translation services to the host system (e.g., cost per translated message provided by a third-party translation service). In certain embodiments, the cost to translate may be augmented with an additional price in order to create a revenue stream for the service provider. In certain embodiments, the additional price could be a flat fee, in other embodiments, the cost could be based on message length.

### Centralized Messaging/Profiles

According to an embodiment of the present invention, the system may be configured to provide users to create centralized messaging boards and/or user profiles. In preferred embodiments, these message boards and user profiles will be only available to receivers that are allowed access by the transmitter. In certain embodiments, portions of a message board or user profile may be made available to receivers, even if they are not allowed full access by a user. One of ordinary skill in the art would appreciate that there are numerous methods for providing various levels of access to a message board or user profile, and embodiments of the present invention are contemplated for use with any appropriate method for providing various levels of access to such features.

In preferred embodiments of the present invention, the system may be configured to automatically translate the message boards and/or user profiles of users into an appropriate language for the receiver. Therefore, a transmitter may have a user profile in a first language and the system may provide the user profile to a receiver in a second language identified by the system and translated for consumption by the receiver. Further, in instances where a message board may have a plurality of languages associated with it (e.g., comment threads), the system may be further configured to translate all languages into the language of the receiver, making it easier for consumption by the receiver.

Similar to above embodiments associated with translation, in certain embodiments, the receiver may receive the message board or user profile in untranslated message format and select individual portions of a user profile or message board to translate at the receiver's desire. Again, for situations where a user is trying to learn a new language, this can be useful to assist with the learning process.

### Exemplary Embodiments

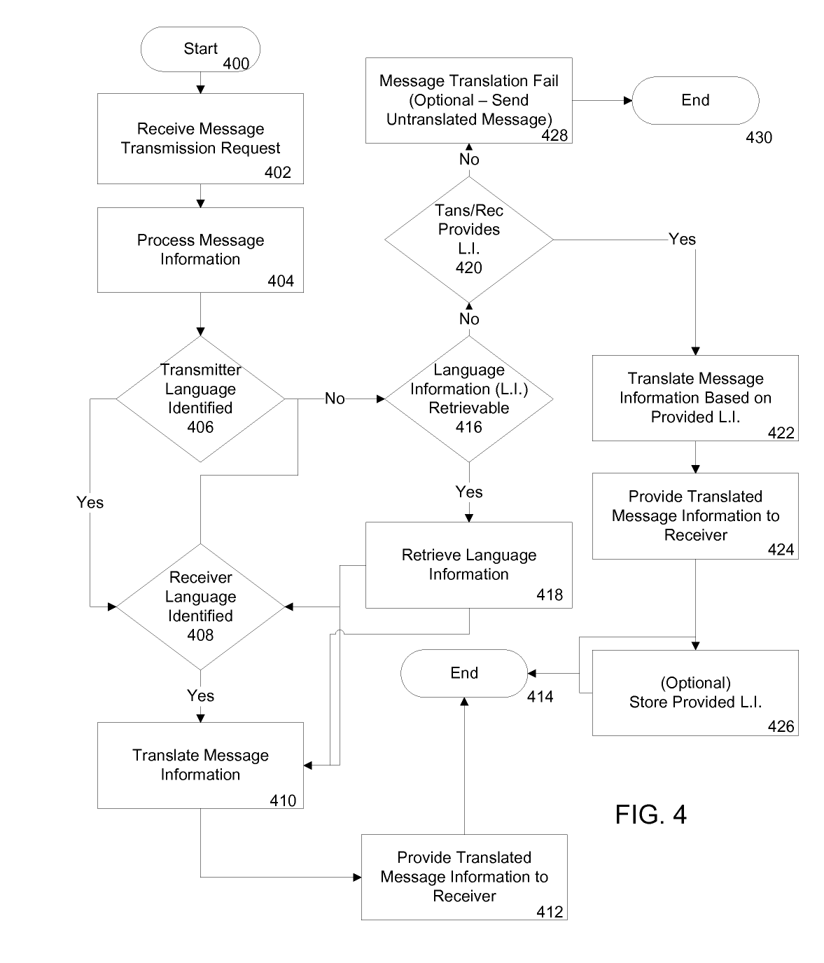

Turning now to FIG. 4, an exemplary method for providing a cross-platform messaging application with translation capabilities, in accordance with embodiments of the present invention is shown. The process starts at step 400 with a transmitter engaging the system to send a message to a receiver. At step 402, the system receives the message transmission request, which comprises the message information and information about how to deliver the message (delivery information) to the receiver (e.g., SMS, proprietary application).

At step 404, the system processes the message information into useable components. For instance, delivery information can be separated from message information for independent processing and utilization. In other embodiments, information may remain together, with processing comprising the identification of various aspects required for the process (e.g., language of transmitter, language of receiver, delivery method, message content). One of ordinary skill in the art would appreciate that there are various means and methods for pre-processing and processing data for transmission, and embodiments of the present invention are contemplated for use with any appropriate method for processing and/or pre-processing such information.

At step 406, the system determines if it can identify the transmitters language. This can be accomplished via any of the methods previously described herein. If the transmitter language is identified, the system checks to see if it can identify the language of the receiver (i.e., language for message to be translated into) (step 408).

If the receiver language is also identified, the system proceeds to step 410, where the message information is translated from the first language (language of the transmitter) into the second language (language of the receiver). After translation, the system provides the translated message information to the receiver (step 412) and the process terminates at step 414.

Returning back to the decision steps at 406 and 408, if the system cannot identify the language of either the transmitter or the receiver, the system may automatically determine if the language in question is retrievable from a remote source (step 416). This may be especially relevant where translation is occurring on the device of a transmitter or receiver and a centralized system may have a more complete database of language information than any individual device. However, there may also be embodiments where a distributed or remote system has access to third-party language libraries not currently available to the distributed or remote system. In these embodiments, the system may be configured to retrieve such language information from such third-party language library, such as via an application programming interface (API).

If the language information is available, the system proceeds to step 418 where the system retrieves the appropriate language information and continues to the next step in the process (either decision 408 if the system retrieved the transmitter language or step 410 if the system retrieved the receiver language).

If the language information is not available, the system proceeds to step 420, where the system determines if the transmitter or receiver is capable of providing the necessary language information. If the transmitter or receiver can provide the necessary language information, the system can then continue with the translation of the message (step 422) and provision of the translated message information to the receiver (step 424), with the process terminating at step 414. In an optional step (step 426), the system may be configured to store the newly provided language information for later use in processing message information with the associated language.

Returning to decision step 420, if no language information is available to the system, the system will fail the message translation process. If this occurs, the system may take one or more optional steps, including, but not limited to, providing the untranslated message information to the receiver and confirming the failed translation to the transmitter. At this point the process terminates at step 430.

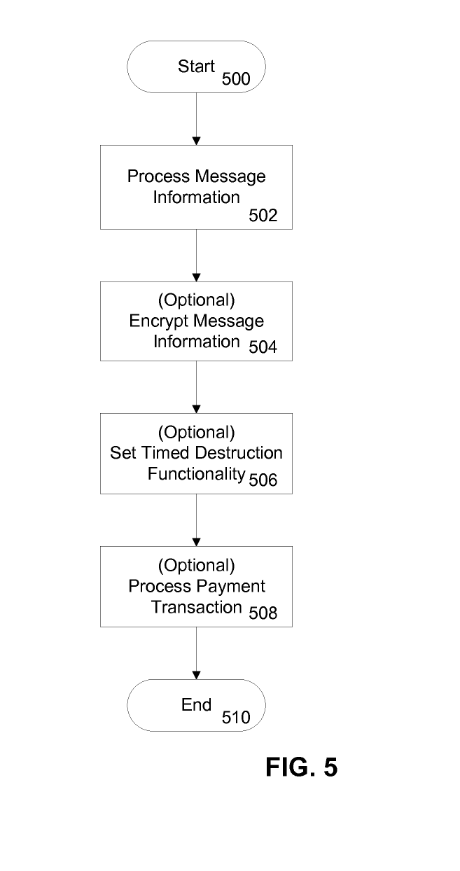

Turning now to FIG. 5, an exemplary method for providing a cross-platform messaging application with translation capabilities, in accordance with embodiments of the present invention is shown. The process starts at step 500 and is generally used in conjunction with the messaging process of FIG. 4. In preferred embodiments, the process in FIG. 5 builds on the process of FIG. 4 by adding additional functionality to the process.

At step 502, message information is processed and the system determines if there are any optional features that are requested for the message information. At step 504, where requested by the transmitter, receiver, system or any combination thereof, the system may encrypt the message information as described previously herein.

At step 506, where requested by the transmitter, receiver, system or any combination thereof, the system may set a timed destruction sequence for the message information as described previously herein.

At step 508, where requested by the transmitter, receiver, system or any combination thereof, the system may process a payment transaction for the transmitter and receiver as described previously herein. After the optional features are processed, the process terminates at step 510.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. There may be aspects of this invention that may be practiced without the implementation of some features as they are described. It should be understood that some details have not been described in detail in order to not unnecessarily obscure focus of the invention. The invention is capable of myriad modifications in various obvious aspects, all without departing from the spirit and scope of the present invention. Accordingly, the drawings and descriptions are to be regarded as illustrative in nature and not restrictive.

1. A universal translator comprising:
a computer machine comprising:
a messaging exchange module comprising computer executable code stored in non-volatile memory;
a processor;
a memory;
and a communications means,
wherein said computer machine is configured to:
receive a message from a sender that is to be sent to a receiver;
identify a language of the sender wherein said messaging exchange module identifies the sender language by comparing individual words or phrases identified in said message to a language database stored in said memory;
identify a language of the receiver, wherein said messaging exchange module identifies the receiver language by acquiring language identifying data from a computing device of the receiver, wherein said language identifying data is meta-data;
compare the sender language to the receiver language;
determine whether the sender language is different from the receiver language;
translate said message into the language of the receiver via a translation process upon determining that the sender language is different from the receiver language; and
send said translated message to the receiver.

2. The universal translator of claim 1, wherein said messaging exchange module, said processor, said memory, and said communications means are operably connected and are further configured to encrypt at least one of said message and said translated message.

3. The universal translator of claim 1, wherein said messaging exchange module, said processor, said memory, and said communications means are operably connected and are further configured to destroy at least one of said message and said translated message automatically after a designated amount of time.

4. (canceled)

5. The universal translator of claim 1, wherein said messaging exchange module, said processor, said memory, and said communications means are operably connected and are further configured to send a payment request from the receiver to the sender.

6. The universal translator of claim 1, wherein said translation process is performed on a remote computing device.

7. The universal translator of claim 1, wherein said translation process is performed on a computing device of the sender or receiver.

8. A method for translating a message via a computing device, the method comprising the steps of:
receiving, at said computing device, a message from a sender intended for a receiver;
identifying, at said computing device, a language of the sender by comparing individual words or phrases identified in said message to a language database stored in said memory;
identifying, at said computing device, a language of the receiver by acquiring language identifying data from a computing device of the receiver, wherein said language identifying data is meta-data;
comparing, at said computing device, said first language to said second language;
determining, at said computing device, whether said first language is different from said second language;
translating, via said computing device, said message into a translated message via a translation process upon determining that said first language is different from said second language; and
sending, via said computing device, said translated message to said receiver.

9. The method of claim 8, further comprising the step of encrypting, via said computing device, at least one of said message and said translated message.

10. The method of claim 8, further comprising the step of destroying, via said computing device, at least one of said message and said translated message automatically after a designated amount of time.

11. The method of claim 8, further comprising the steps of:
receiving, at said computing device, a payment request approval from said sender, wherein said sender authorizes a payment to be removed from a payment account belonging to said sender;
transferring, via said computing device, said payment from said sender to a deposit account belong to said receiver.

12. The method of claim 11, further comprising the step of sending, via said computing device, a payment request from said receiver to said sender.

13. The method of claim 8, wherein said translation is performed on a remote computing device.

14. The method of claim 8, wherein said translation process is performed on a computing device of the sender or receiver.

15. The universal translator of claim 5, wherein said messaging exchange module, said processor, said memory, and said communications means are further configured to:
receive a payment request approval from the sender, wherein the sender authorizes a payment to be removed from a payment account belonging to the sender;
transfer said payment from the sender to the receiver, wherein said payment is deposited in a deposit account belonging to the receiver.
